(19) United States
(12) Patent Application Publication
(10) Pub. No.: US 2015/0086180 A1
(43) Pub. Date: Mar. 26, 2015

(54) System and Method for Delivering Video Program in a Cloud

(71) Applicant: Yang Pan, Singapore (SG)

(72) Inventor: Yang Pan, Singapore (SG)

(21) Appl. No.: 14/033,468

(22) Filed: Sep. 22, 2013

(51) Int. Cl. G11B 27/10; H04N 21/472; H04N 21/81

(52) U.S. Cl. CPC G11B 27/10; H04N 21/812; H04N 21/47217
USPC 386/241

(57) ABSTRACT

A video program delivery system comprises a digital television system, various mobile computing and communication devices and a communication network. A video program rendered by the television system or by anyone of the mobile devices can be paused. A bookmark is then created. The bookmark can be transmitted to a bookmark manager in the communication network. A user can access the bookmarks in the communication network through the television system or anyone of the mobile devices. An unfinished program can be resumed after associated bookmark is selected. The bookmark may include a frame associated with the unfinished program.

### CROSS-REFERENCE TO RELATED APPLICATIONS

The present application is related to patent application 14032185, field on Sep. 19, 2013 by the same applicant.

### BACKGROUND

1. Field of the Invention

This invention relates generally to media asset delivery. More specifically, the invention relates to system and method for delivering a video program through the use of a digital television system and a mobile computing and communication device.

2. Description of Prior Art

Mobile communication devices have gained significant popularity in recent years. Users are using the mobile device such as, for example, iPhone, iPod and iPad from Apple Inc, Cupertino, Calif., to enjoy media assets and to access the Internet services. Methods for delivering video programs to users by employing mobile communication devices have been developed.

Because of significantly larger display size and comfortable environment in a living room, many of video programs have still been delivered to users through a digital television system. However, a user is often disrupted for different engagements when viewing a video program. A video program being rendered has to be paused or be stopped sometimes.

Therefore, it is desirable to have a flexible video program delivery system which can be employed to deliver an unfinished video program either through one of the mobile communication devices or through the digital television system in a later time.

### SUMMARY OF THE INVENTION

It is an object of the present invention to have a system and method providing flexibility for delivering an unfinished video program using different personal devices.

It is another object of the present invention to enable a user to access the unfinished video program through anyone of personal devices connected to the cloud.

It is yet another object of the present invention to provide a simple graphical user interface for a user to resume the unfinished video program.

A video program can be rendered on a user demand base or be broadcasted according to a predetermined schedule. A digital television (TV) system or anyone of mobile devices can be used to receive the video program. The program comprises a series of frames or images. A bookmark is created for an unfinished program. The bookmark is then transmitted to a bookmark manager in the cloud. Received bookmark is stored in a data storage unit of the bookmark manager. More than one bookmark received from different devices and at different times can be stored in a data file stored in the bookmark manager. The storage unit may be a virtual storage unit in the cloud.

A user can access the stored bookmarks through the digital TV system or anyone of the personal mobile devices such as, for example, a smart phone, a tablet computer and a handheld media player. The bookmark manager renders the bookmarks to the user through a user interface by an UI engine. In one aspect, the bookmarks are icons representing unfinished video program. In one implementation, a bookmark includes a frame representing the starting point of a remaining part of the video program. The bookmark in a form of icon may include the frame in a reduced size. In another aspect, a bookmark includes a video clip representing the part of the video program that has been rendered.

Upon the user's selection of the bookmark, the unfinished video program is delivered from a media provider in the cloud to the digital TV system or to anyone of the personal devices being used by the user.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of an exemplary video delivery system based on a digital TV system and a mobile communication device;

FIG. 2 is a schematic diagram illustrating that the bookmark manager renders a plurality of bookmarks in a form of user selectable icons through a mobile device;

FIG. 3 is a schematic diagram illustrating that the bookmark manager renders a plurality of bookmarks in a form of user selectable icons through a digital TV system;

FIG. 4 is a flowchart illustrating an exemplary process that a video program is delivered initially by the digital TV system and is resumed by a mobile device;

FIG. 5 is a flowchart illustrating an exemplary process that a video program is delivered initially by a mobile device and is resumed by the digital TV system.

### DETAILED DESCRIPTION

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefits of this disclosure.

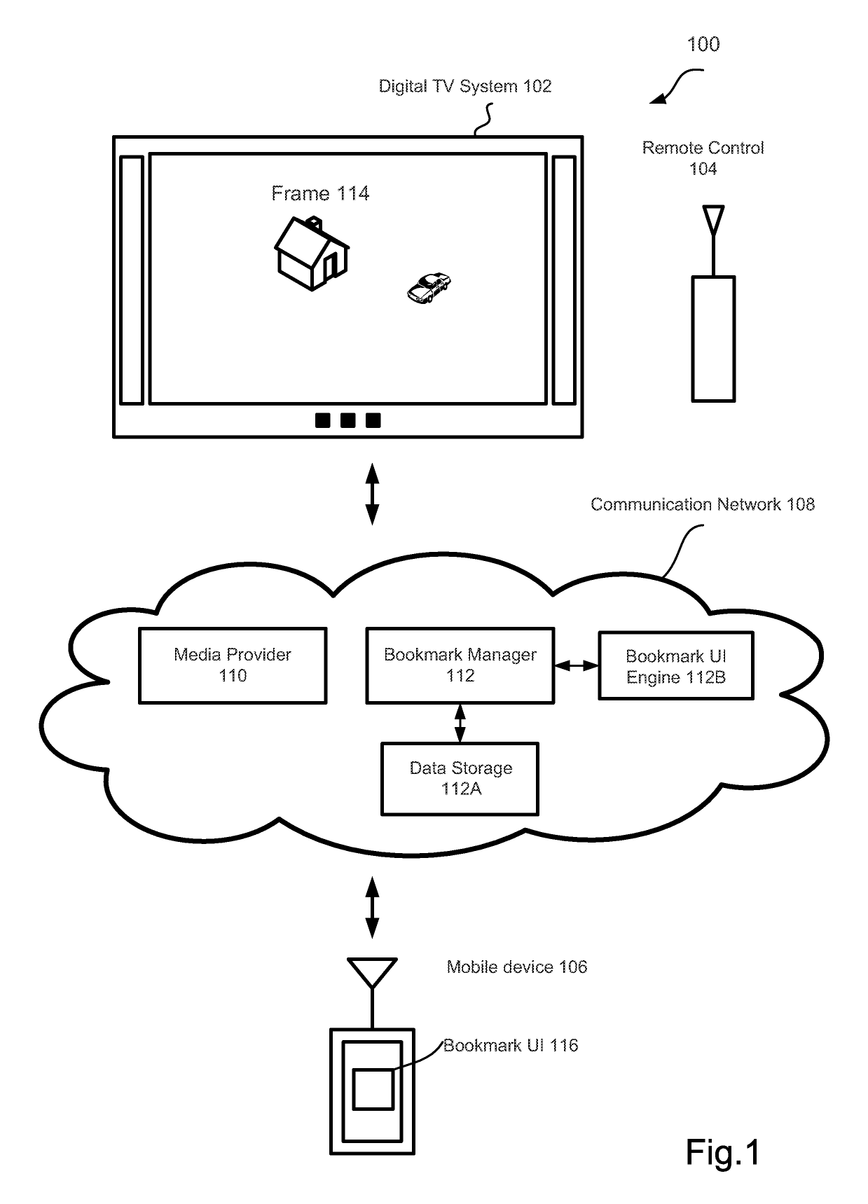

FIG. 1 is a schematic diagram illustrating an exemplary video delivery system according to one embodiment. System 100 comprises digital TV system 102 with a remote control device 104. System 100 further comprises a mobile computing and communication device 106. System 100 may include more than one digital TV system and include more than one type of mobile device. Digital TV system 102 is connected to a communication network 108 and is controlled by a computing device such as, for example, a set-top-box. Digital TV system 102 can be connected to communication network 108 through various means that include but are not limited to a cable based broadband type of connection, an optical fiber based broadband connection, a broadband wireless connection and a satellite based wireless connection.

Mobile device 106 can take various forms that include but are not limited to a smart phone, a tablet computer, a media player, a laptop computer, a wearable communication device and a game console. Mobile device 106 is connected to network 108 through a network communication interface.

Communication network 108 includes the Internet in an exemplary case. Communication network 108 further includes a media provider 110 pertaining to delivering media assets including video programs to digital TV system 102 and to mobile device 106. Video programs are used throughout the present disclosure to illustrate the present inventive concept. The inventive concept is not limited to the video program delivery. The scope of the present inventive concept also includes but is not limited to audio assets, text, images, photographs and websites as obvious to one with ordinary skill in the art.

Communication network 108 further includes bookmark manager 112 pertaining to receiving, storing and delivering the bookmarks. Bookmark manager 112 includes a data storage unit 112A for storing received bookmarks. Bookmark manager 112 further includes a software program pertaining to render bookmarks to digital TV system 102 or mobile device 106 through a user interface engine 112B. The software program may be executed by a server or a virtual server associated with bookmark manager 112.

In an exemplary case, a video program comprising a plurality of frames is delivered through digital TV system 102. The frames are delivered in a sequential manner At a pausing point of the video program, frame 114 being displayed is recorded by the processor of digital TV system 102. Each of the frames of the video program may be associated with an address. Frame 114 may be associated with an identification code. The identification code may be related to the address representing the frame. A bookmark is created by the processor representing the pausing point of the video program. The video program can be divided into a first part that has been rendered and a second part or the remaining part that has not been rendered. The pausing point can be created by a user employing remote control device 104. The pausing point can also be created by a user through a user interface and be executed by the processor of digital TV system 102 according to a schedule.

In one aspect, the bookmark is a representation of the recorded frame representing the pausing point. In another aspect, the bookmark is a video clip that includes a portion of the first part of the video program. In one implementation, the video clip includes a part of video program before the pausing point. The video clip may have a duration ranging from 2 second to 10 minutes. In another implementation, the bookmark includes multiple video clips in the first part of the video program. In still another implementation, the bookmark includes video clips in the second part or the remaining part of the video program.

In another implementation, bookmarks may be associated with advertising messages. The video program can only be resumed after the advertising messages are viewed.

The created bookmark is transmitted to bookmark manger 112 from digital TV system 102 and be stored in data storage unit 112A. Bookmark manager 112 may create a database or data file for a user of system 100. The user has to be identified before the bookmark is transmitted to bookmark manager 112.

A user of digital TV system 102 and mobile device 106 can be identified by a login procedure. A user can also be identified by a biometric sensor that includes but is not limited to a fingerprint sensor and an image sensor. A user can further be identified by transmitting a user's identity from a mobile device to the digital TV system.

Bookmark user interface 116 can be initiated by the user's actuating of an input device of mobile device 106 or by actuating of an application icon. Upon receiving the user's actuation, mobile device 106 is connected to bookmark manager 112 in network 108. Bookmark UI engine 112B renders bookmark user interface 116 on a display of mobile device 106. The user selects the bookmark representing the unfinished video program. In response to the user's selection, the remaining part of the video program is resumed by the mobile device 106. The remaining part of the video program is delivered from media provider 110 to mobile device 106.

In one implementation, the user may view the video clip associated with the bookmark at a first step and then make a confirmation through an input device of the mobile device 106 to resume the remaining part of the video program.

In another implementation, an advertising message associated with the bookmark is rendered before the remaining part of the video program is delivered.

In still another implementation, the user pays for resuming the video program through an on-line payment facility.

In one aspect, the first part of video program is delivered using digital TV system 102 and the second part is delivered using mobile device 106.

In another aspect, the first part is delivered using mobile device 106 and the second part is delivered using digital TV system 102.

In yet another aspect, the first part is delivered using digital TV system 102 and the second part is delivered using the same or a different digital TV system.

In still another aspect, the first part is delivered using mobile device 102 and the second part is delivered using the same or a different mobile device.

The delivery of a video program may also involve more than one pausing point and may involve several different apparatus or devices.

In one aspect, media provider 110 and bookmark manager 112 belong to different entities. In another aspect, they belong to the same entity.

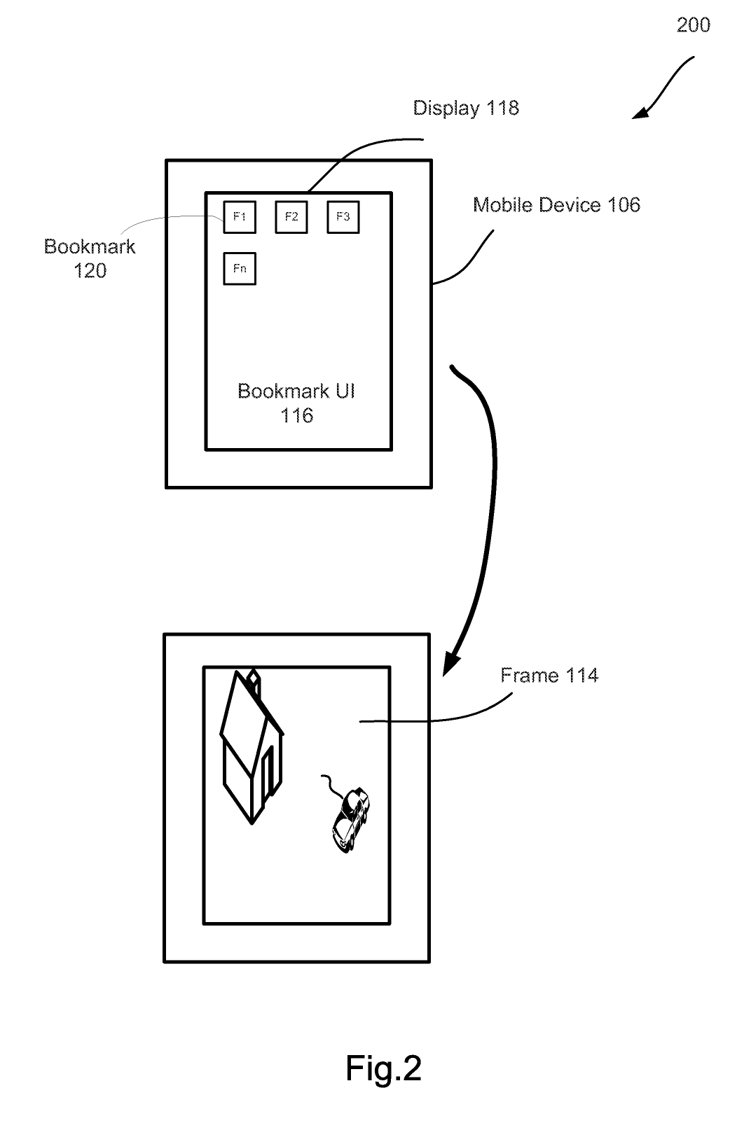

FIG. 2 is a schematic diagram illustrating that the bookmark manager 112 renders a plurality of bookmarks 120 in a form of user selectable icons through a mobile device 106. According to system 200, mobile device 106 includes a display 118. In an exemplary case, display 118 is a touch-sensitive display. Bookmark UI engine 112B displays bookmark UI 116 on display 118. UI 116 includes in an exemplary manner a plurality of icons F1 to Fn. At least one of the icons includes an image of frame 114 in a reduced size. The icons may also be associated optionally with text or animations.

The user may select one of the icons through an input device of mobile device 106 to resume the video program. In one implementation, frame 114 is redisplayed on display 118 upon receiving the user's selection of the associated icon. The remaining portion of the video program is delivered subsequently from media provider 110 and is rendered by mobile device 106.

In another implementation, a video clip related to the first part of the video program may be delivered first and the remaining part of the video program is delivered subsequently.

In yet another implementation, an advertising message is rendered before the remaining part of the video program is delivered.

Bookmark manager 112 may ask the user to verify his or her identity before the bookmarks are displayed.

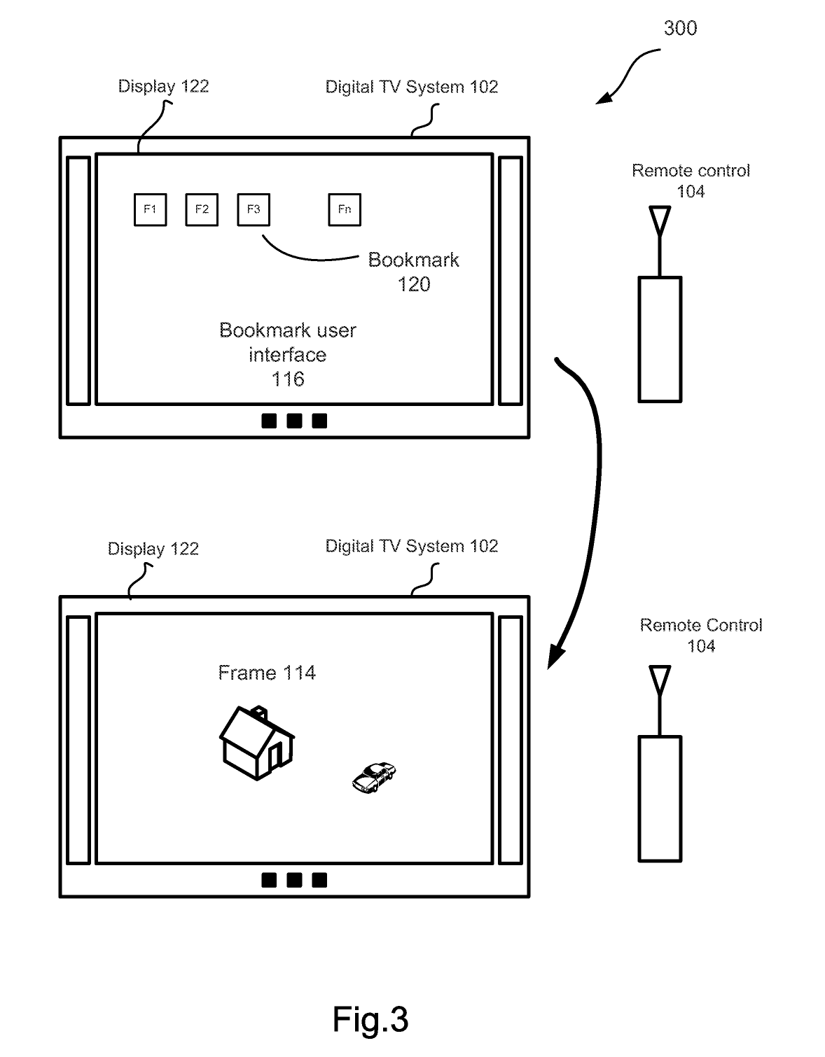

FIG. 3 is a schematic diagram illustrating that the bookmark manager 112 renders a plurality of bookmarks 120 in a form of user selectable icons through digital TV system 102. According to system 300, digital TV system 102 includes a display 122. In an exemplary case, display 122 is a liquid crystal display (LCD). Bookmark UI engine 112B displays bookmark UI 116 on display 122. UI 116 includes in an exemplary manner a plurality of icons F1 to Fn. At least one of the icons includes an image of frame 114 in a reduced size. The icons may also be associated optionally with text or animations.

The user may select one of the icons through remote control 104 to resume the video program. In one implementation, frame 114 is redisplayed on display 122 upon receiving the user's selection of the associated icon. The remaining part of the video program is delivered from media provider 110 and is rendered by digital TV system 102.

In another implementation, a video clip related to the first part of the video program may be delivered first and the remaining part of the video program is delivered subsequently.

In yet another implementation, an advertising message is rendered before the remaining part of the video program is delivered.

Bookmark manager 112 may ask the user to verify his or her identity before the bookmarks are displayed.

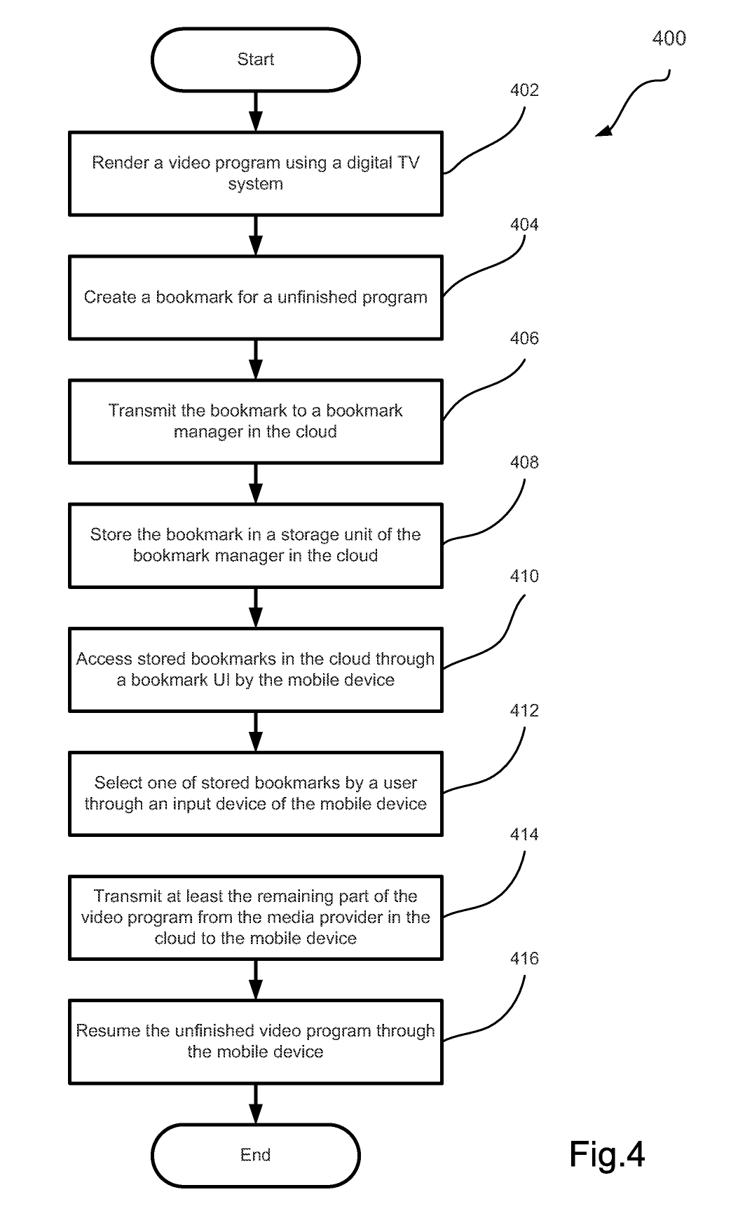

FIG. 4 is a flowchart illustrating an exemplary process that a video program is delivered initially by digital TV system 102 and is resumed by mobile device 106. Process 400 starts with step 402 that a video program is rendered by digital TV system 102. At a point of pausing, typically triggered by a user's actuation of remote control 104, a bookmark is created in step 404 representing unfinished part of the program. The bookmark may be related to the frame being displayed at the point of pausing. The bookmark may also be related to a video clip including a part of video program that has been rendered. In step 406, the bookmark is transmitted from digital TV system 102 to bookmark manager 112 in network or the cloud 108 through a communication interface in digital TV system 102. Upon receiving the bookmark, data storage unit 112A in the bookmark manager 112 stores the bookmark in a database or a data file in step 408.

In the present implementation, mobile device 106 is connected to bookmark manager 112 through communication network 108. In an exemplary case, communication network 108 is the Internet. The bookmarks stored in bookmark manager 112 can be accessed by the user employing mobile device 106 in step 410. Bookmark UI engine 112B renders the bookmarks to the user through bookmark UI 116. In step 412, the user selects one of the bookmarks through an input device of mobile device 106. The remaining part of the video program is transmitted from media provider 110 to mobile device 106 in step 414. In one implementation, advertising messages may be transmitted before or together with the transmitting of the video program. In another implementation, the video clips associated with the selected bookmark may be delivered. The unfinished video program is resumed in step 416 through mobile device 106.

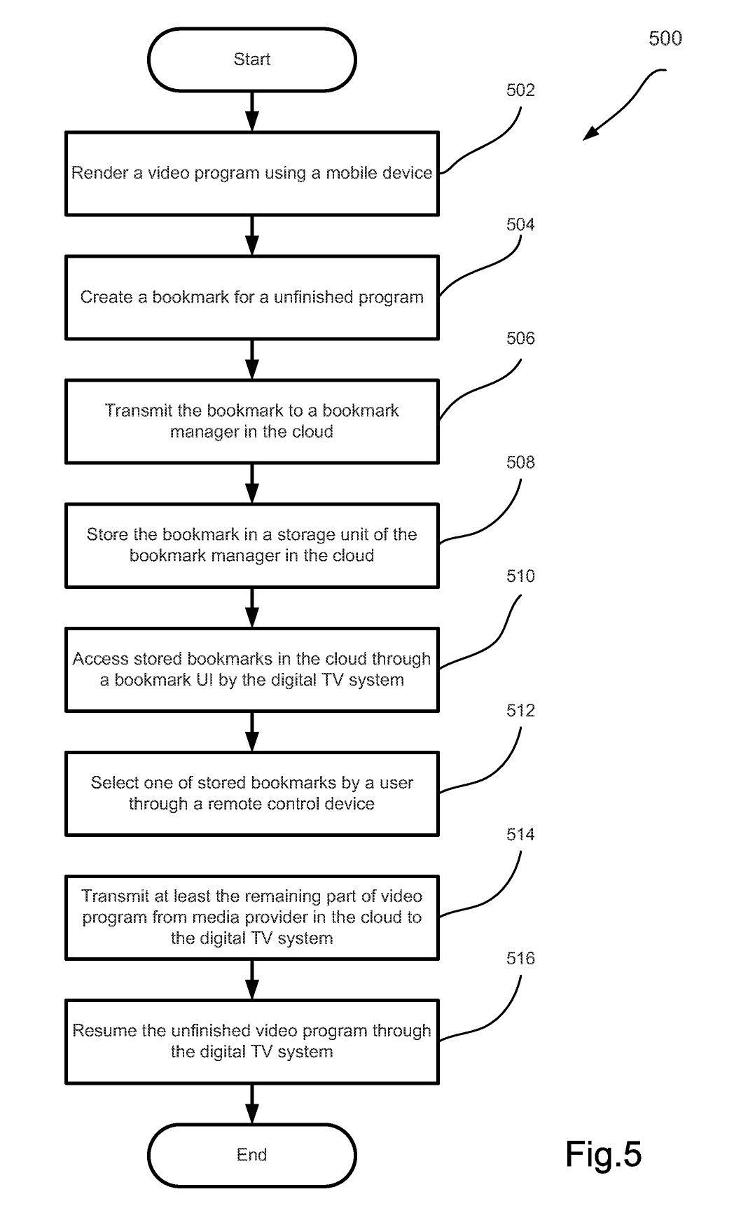

FIG. 5 is a flowchart illustrating an exemplary process that a video program is delivered initially by mobile device 106 and is resumed by digital TV system 102. Process 500 starts with step 502 that a video program is rendered by mobile device 106. At a point of pausing, typically triggered by a user's actuation of an input device of mobile device 106, a bookmark is created in step 504 representing unfinished part of the program. The bookmark may be associated with the frame being displayed at the point of pausing. The bookmark may also be related to a video clip including a part of video program that has been rendered. In step 506, the bookmark is transmitted from mobile device 106 to bookmark manager 112 in network 108 through a network interface in mobile device 106. Upon receiving the bookmark, data storage unit 112A in the bookmark manager 112 stores the bookmark in a database or a data file in step 508.

In the present implementation, digital TV system 102 is connected to bookmark manager 112 through communication network 108. In an exemplary case, communication network 108 is the Internet. The bookmarks stored in bookmark manager 112 can be accessed by the user employing digital TV system in step 510. Bookmark UI engine 112B renders the bookmarks to the user through bookmark UI 116. In step 512, the user selects one of the bookmarks through remote control 104. The remaining part of the video program is transmitted from media provider 110 to digital TV system in step 514. In one implementation advertising messages may be transmitted before or together with the transmitting of the video program. In another implementation, the video clips associated with the selected bookmark may be delivered. The unfinished video program is resumed in step 516 through digital TV system 102.

1. A method of delivering a video program through a video program delivery system comprising a digital television system, a mobile computing and communication device and a communication network, the method comprising:
a. rendering the video program by the television system;
b. creating a bookmark for unfinished video program by a processor in the television system;
c. transmitting said bookmark by the processor to a bookmark manager in the communication network;
d. storing said bookmark by said bookmarker manager in a data storage unit;
e. rendering stored bookmarks to a user of the mobile device through a user interface by a user interface engine in said bookmark manager, said mobile device is connected to the communication network;
f. selecting the bookmark representing the unfinished video program by the user through a user input device of the mobile device;
g. rendering the unfinished program through the mobile device, said unfinished program is delivered from a media provider to the mobile device through the communication network.

2. The method as recited in claim 1, wherein said video program further comprises a plurality of frames delivered in a sequential manner by the television system, said bookmark is associated with one of the frames.

3. The method as recited in claim 2, wherein said bookmark is rendered by the user interface as an icon.

4. The method as recited in claim 3, wherein said icon further includes a frame in a reduced size.

5. The method as recited in claim 1, wherein said bookmark further includes a video clip, said video clip is a part of the video program.

6. The method as recited in claim 1, wherein said method further comprises rendering an advertising message by the mobile device before the unfinished video program is resumed.

7. The method as recited in claim 1, wherein said bookmark manager is a software program stored in a server or a virtual server in the communication network.

8. The method as recited in claim 1, wherein said bookmark manager is a part of said media provider.

9. A method of delivering a video program through a video program delivery system comprising a digital television system, a mobile computing and communication device and a communication network, the method comprising:
a. rendering the video program by the mobile device;
b. creating a bookmark for unfinished video program by a processor in the mobile device;
c. transmitting by the mobile device said bookmark to a bookmark manager in the communication network;
d. storing said bookmark by said bookmark manager in a data storage unit;
e. rendering stored bookmarks by a user interface engine of said bookmark manager to a user of the television system, said television system is connected to the communication network;
f. selecting the bookmark representing the unfinished video program by the user through a remote control device;
g. rendering the unfinished program through the television system, said unfinished program is delivered from a media provider to the television system through the communication network.

10. The method as recited in claim 9, wherein said video program comprises a plurality of frames delivered in a sequential manner by the mobile device, said bookmark is associated with one of the frames.

11. The method as recited in claim 10, wherein said bookmark is rendered by the user interface as an icon, wherein said icon further includes a frame in a reduced size.

12. The method as recited in claim 9, wherein said bookmark further includes a video clip, said video clip is a part of the video program.

13. The method as recited in claim 9, wherein said method further comprises rendering an advertising message by the television system before the unfinished program is resumed.

14. A video program delivery system comprising:
a. a communication network;
b. at least one digital television system connected to the communication network;
c. at least one mobile computing and communication device connected to the communication network;
d. a bookmark manager in the communication network pertaining to storing bookmarks representing unfinished video programs rendered by the television system or by the mobile device;
e. a user interface controlled by said bookmark manager pertaining to rendering the bookmarks through the digital television system and the mobile device; and
f. a means for delivering one of unfinished video programs after the representing bookmark is selected by a user through said user interface.

15. The system as recited in claim 14, wherein said bookmark manager further comprises a user interface engine and a data storage unit.

16. The system as recited in claim 14, wherein said system further comprises a media provider in the communication network.

17. The system as recited in claim 14, wherein said video program comprises a plurality of frames delivered in a sequential manner, wherein said bookmark is associated with one of the frames.

18. The system as recited in claim 17, wherein said bookmarks are rendered as a user selectable icons by said user interface; wherein said icons further comprise frames in reduced sizes.

19. The system as recited in claim 14, wherein said bookmark further includes a part of video program.

20. The system as recited in claim 19, wherein said part of the video program is rendered to the user through the digital television system or the mobile device after said bookmark is selected.
